(19) United States
(12) Patent Application Publication
(10) Pub. No.: US 2015/0192711 A1
(43) Pub. Date: Jul. 9, 2015

(54) DIFFRACTIVE OPTICAL ELEMENT, PRODUCTION METHOD FOR THE DIFFRACTIVE OPTICAL ELEMENT, AND MOLD USED IN THE PRODUCTION METHOD FOR THE DIFFRACTIVE OPTICAL ELEMENT

(71) Applicant: Panasonic Intellectual Property Management Co., Ltd., Osaka (JP)

(72) Inventors: YUKA OKADA, Hyogo (JP); KOUICHIROU MATSUOKA, Kyoto (JP)

(21) Appl. No.: 14/659,546

(22) Filed: Mar. 16, 2015

Related U.S. Application Data
(63) Continuation of application No. PCT/JP2014/003187, filed on Jun. 16, 2014.

(30) Foreign Application Priority Data
Jul. 29, 2013 (JP) 2013-157197

(51) Int. Cl. G02B 5/18

(52) U.S. Cl. CPC G02B 5/18; G02B 5/1852

(57) ABSTRACT

A diffractive optical element includes a base having, on a surface, a first region with a diffraction grating and a second region located on an outer side of the first region, and an optical adjustment layer provided on the surface to be in contact with the first region and at least a part of the second region. A thin film portion having a film thickness smaller than a maximum film thickness of a portion of the optical adjustment layer in contact with the second region is provided in at least a part of the portion of the optical adjustment layer in contact with the second region.

### BACKGROUND

1. Technical Field

The present disclosure relates to a diffractive optical element, a production method for the diffractive optical element, and a mold used in the production method for the diffractive optical element.

2. Description of the Related Art

A diffractive optical element has a structure in which a diffraction grating for diffracting light is provided on a base formed of an optical material such as glass or resin. The diffractive optical element is used in various optical systems including an imaging device and an optical recording device. As the diffractive optical element, for example, a lens designed to collect diffraction light of a specific order at one point, a spatial low-pass filter, or a polarization hologram element is known.

The diffractive optical element has the advantage in allowing the optical system to be compact. Further, unlike refraction, light with a longer wavelength undergoes greater diffraction. Hence, chromatic aberration or curvature of field of the optical system can be corrected by combining the diffractive optical element with a normal optical element utilizing refraction.

As a production method for the diffractive optical element, there is known a replica molding process that achieves high large-area moldability and high transferability. Japanese Unexamined Patent Application Publication No. 2012-232449 and Japanese Unexamined Patent Application Publication No. 2007-326330 each disclose a method for producing a composite optical element including a diffractive optical element by a replica molding process.

In the method disclosed in Japanese Unexamined Patent Application Publication No. 2012-232449, a mold is first prepared. The mold includes an optical effective part for shaping a resin layer of a composite optical element, two banks concentrically disposed outside the optical effective part, and a groove disposed between the banks. Next, resin is dropped onto the mold, and a base is pressed while abutting on the two banks. After the resin is cured, the cured resin layer and the base are released together from the mold. Since the outward flow of the resin is weakened by the groove and the outer bank, the flow of the resin flowing in an unfilled area of the optical effective part is increased. Therefore, it is possible to sufficiently fill the optical effective part of the mold with the resin and to prevent the resin from overflowing to the outside of the mold.

In the method disclosed in Japanese Unexamined Patent Application Publication No. 2007-326330, a mold having a projecting portion, which has a height within the range of 70% to 90% of the resin thickness of a photocurable resin, out of an optical effective molding face of a molding surface is prepared. The photocurable resin filled in the Bolding surface with pressure is photocured, and is released together with a glass base from the mold. This method can enhance releasability of the molding resin, and can achieve improvement of production efficiency and cost reduction.

On the other hand, since the diffraction efficiency depends on the wavelength of light in theory, when a diffractive optical element is designed so that the diffraction efficiency is optimized at a specific wavelength, the diffraction efficiency decreases at the other wavelengths. For example, when a diffractive optical element is used in an optical system using white light, color unevenness or flare due to diffracted light of an unnecessary order is caused owing to the wavelength dependence of the diffraction efficiency. The optical system using white light is, for example, a lens for a camera.

Accordingly, Japanese Unexamined Patent Application Publication No. 10-268116 and Japanese Unexamined Patent Application Publication No. 2001-249208 each disclose a method for reducing the wavelength dependence of the diffraction efficiency. Japanese Unexamined Patent Application Publication No. 10-268116 discloses that a phase-difference type diffractive optical element is structured by forming a diffraction grating on a surface of a base made of an optical material and covering the diffraction grating with an optical adjustment layer made of an optical material different from the optical material of the base. According to this diffractive optical element, the diffraction efficiency at a designed diffraction order can be made high regardless of the wavelength, that is, the wavelength dependence of the diffraction efficiency can be reduced by selecting the two optical materials so that the optical characteristics satisfy predetermined conditions.

When the following Expression 1 is satisfied, the diffraction efficiency with respect to light having a wavelength λ is 100%:

$$d = \frac{λ}{\vert n 1 ( λ ) - n 2 ( λ ) \vert} \qquad ( 1 )$$

where λ represents the wavelength of light passing through the diffractive optical element, n1(λ) and n2(λ) represent the refractive indices of two kinds of optical materials at the wavelength λ, and d represents the depth of the diffraction grating.

Therefore, the wavelength dependence of the diffraction efficiency is reduced by combining an optical material having a refractive index n1(λ) and an optical material having a refractive index n2(λ) which have such a wavelength dependence that d is substantially constant in a wavelength band of light to be used. In general, a material having high refractive index and low dispersion and a material having low refractive index and high dispersion are combined. Japanese Unexamined Patent Application Publication No. 10-268116 discloses that glass or resin is used as a first optical material serving as a base and ultraviolet curable resin is used as a second optical material.

Japanese Unexamined Patent Application Publication No. 2001-249208 discloses a phase-difference diffractive optical element having a similar structure, in which glass is used as a first optical material and energy curable resin having a viscosity of 5000 mPa·s or less is used as a second optical material. According to this diffractive optical element, it is possible to reduce the wavelength dependence of the diffraction efficiency and to effectively avoid, for example, color unevenness and flare due to diffracted light of an unnecessary order.

### SUMMARY

One non-limiting and exemplary embodiment provides a diffractive optical element that restricts bubbles from remaining within an optical adjustment layer and/or on an interface between a base and the optical adjustment layer and that is excellent in productivity and long-term reliability, a production method for the diffractive optical element, and a mold used in the production method.

In one general aspect, the techniques disclosed here feature a diffractive optical element including a base having, on a surface, a first region with a diffraction grating and a second region located on an outer side of the first region, and an optical adjustment layer provided on the surface to be in contact with the first region and at least a part of the second region. A thin film portion having a film thickness smaller than a maximum film thickness of a portion of the optical adjustment layer in contact with the second region is provided in at least a part of the portion of the optical adjustment layer in contact with the second region. A rugged shape having ruggedness finer than the film thickness of the thin film portion is provided in at least a part of a surface shape of the optical adjustment layer in contact with the second region of the base.

According to the present disclosure, it is possible to provide a diffractive optical element that restricts bubbles from remaining within an optical adjustment layer and/or on an interface between a base and the optical adjustment layer and that is excellent in productivity and long-term reliability, a production method for the diffractive optical element, and a mold used in the production method.

It should be noted that general or specific embodiments may be implemented as a system or a method, or may be implemented as any selective combination of an element, a system, a device, and a method.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a top view of a diffractive optical element according to a first embodiment;

FIG. 1B is a cross-sectional view of the diffractive optical element according to the first embodiment;

FIG. 2A is an overall cross sectional view of a diffractive optical element of the related art;

FIG. 2B is an enlarged view of the diffractive optical element of the related art;

FIG. 2C is a cross-sectional view of the diffractive optical element of the related art;

FIG. 3A is an overall cross-sectional view of the diffractive optical element of the first embodiment;

FIG. 3B is an enlarged view of the diffractive optical element of the first embodiment;

FIG. 3C is an enlarged view of the diffractive optical element of the first embodiment;

FIG. 4 is a cross-sectional view of a diffractive optical element according to a second embodiment;

FIG. 5A is an enlarged view of a diffractive optical element of a second embodiment;

FIG. 5B is an enlarged view of the diffractive optical element of the second embodiment;

FIG. 6A is a top view of a diffractive optical element according to a third embodiment;

FIG. 6B is a cross-sectional view of a mold corresponding to the diffractive optical element according to the third embodiment;

FIG. 6C is a cross-sectional view of the diffractive optical element according to the third embodiment;

FIG. 7A is a cross-sectional view illustrating a part of a method for producing the diffractive optical element of the first embodiment;

FIG. 7B is a cross-sectional view illustrating another part of the method for producing the diffractive optical element of the first embodiment;

FIG. 7C is a cross-sectional view illustrating another part of the method for producing the diffractive optical element of the first embodiment;

FIG. 7D is a cross-sectional view illustrating another part of the method for producing the diffractive optical element of the first embodiment; and

FIG. 8 is an explanatory view of a fine rugged portion.

### DETAILED DESCRIPTION

### Underlying Knowledge Forming Basis of the Present Disclosure

The inventor of the present disclosure found that bubbles remained in the optical adjustment layer within the effective region in the phase-difference diffractive optical element disclosed in each of Japanese Unexamined Patent Application Publication No. 10-268116 and Japanese Unexamined Patent Application Publication No. 2001-249208, particularly when both the base and the optical adjustment layer were formed of materials containing resin, and studied control factors thereof. As a result the inventor of the present disclosure found that, when the conventional phase-difference diffractive optical element was produced using, as the material of the optical adjustment layer, a material having a viscosity of 1000 Pa·s or less at 60° C., the optical adjustment layer markedly tended to be formed while bubbles remained in recesses of the diffraction grating provided on the surface of the base.

The opinions of the inventor on the mechanism with which bubbles remain in the optical adjustment layer will be described below. In a typical phase-difference diffractive optical element, the raw material of an optical adjustment layer is supplied between a base having a diffraction grating on its surface and a mold for defining an aspherical shape, and pressing force is applied between the base and the mold, so that the raw material of the optical adjustment layer flows while filling a cavity including the diffraction grating, and is supplied in an effective region. However, if the above-described low-viscosity material that is easy to treat is used as the raw material of the optical adjustment layer, the raw material of the optical adjustment layer preferentially flows along the mold having an aspherical smooth shape when the pressing force is applied, but does not follow the diffraction grating having ruggedness. It is considered that, as a result of that, the raw material of the optical adjustment layer is not filled in the recesses of the diffraction grating, and causes remaining of bubbles.

Particularly when the material containing resin is used for both the base and the optical adjustment layer, the selection range of the optical characteristics of the resin are limited more than that of glass, and therefore, the depth d of the diffraction grating tends to increase, according to Expression 1. Therefore, the above-described remaining of bubbles is more likely to occur.

When bubbles thus remain in the optical adjustment layer within the effective region, incident light is scattered by the bubbles, and this markedly deteriorates the optical characteristics. When the incident light is scattered, for example, a flare occurs, a ghost occurs, or the contrast decreases. If scattering of the incident light is conspicuous, imaging itself is impossible. Further, it was confirmed that deterioration of the environment resistance, for example, the occurrence of a crack from a remaining bubble in the optical adjustment layer, occurred actually.

In contrast, the present inventor found that the above-described remaining of bubbles rarely occurred when a high-viscosity material having a viscosity of 1000 Pa·s or more at 60° was used as the raw material of the optical adjustment layer. It is considered that bubbles rarely remain because, when the pressing force is applied, the raw material of the optical adjustment layer slowly moves in the cavity while following the diffraction grating on the surface of the base and pushes aft existing in the recesses of the diffraction grating to the outside of the effective region.

When the high-viscosity material is thus used, there is an advantage in the term of the remaining bubbles. However, a problem in production, such as productivity, was confirmed. Specifically, it is considerably difficult to stably supply the material of the optical adjustment layer on the base. For example, the yield of the diffractive optical element is reduced by incomplete formation of the optical adjustment layer due to the shortage of the supply amount or by a shape defect of the optical adjustment layer due to excessive supply amount. Further, productivity is reduced, for example, supply itself takes much time because the raw material of the optical adjustment layer needs to be heated when deposited. Still further, when the viscosity is too low, that is, is 1 Pa·s or less, for example, even when the optical adjustment layer is formed and mounted in a lens, imaging is not performed. This causes a production problem.

While the above-described mechanism is described, as an example, the case in which the raw material of the optical adjustment layer is supplied on the base by using the mold, it is considered to be applicable to general processes in which the raw material of the optical adjustment layer is filled in the diffraction grating by the application of pressing force, for example, screen printing or pad printing. On the basis of the above knowledge, the inventor of the present disclosure has reached the following technical idea.

### First Embodiment

A diffractive optical element according to a first embodiment of the present disclosure will be described below with reference to the drawings.

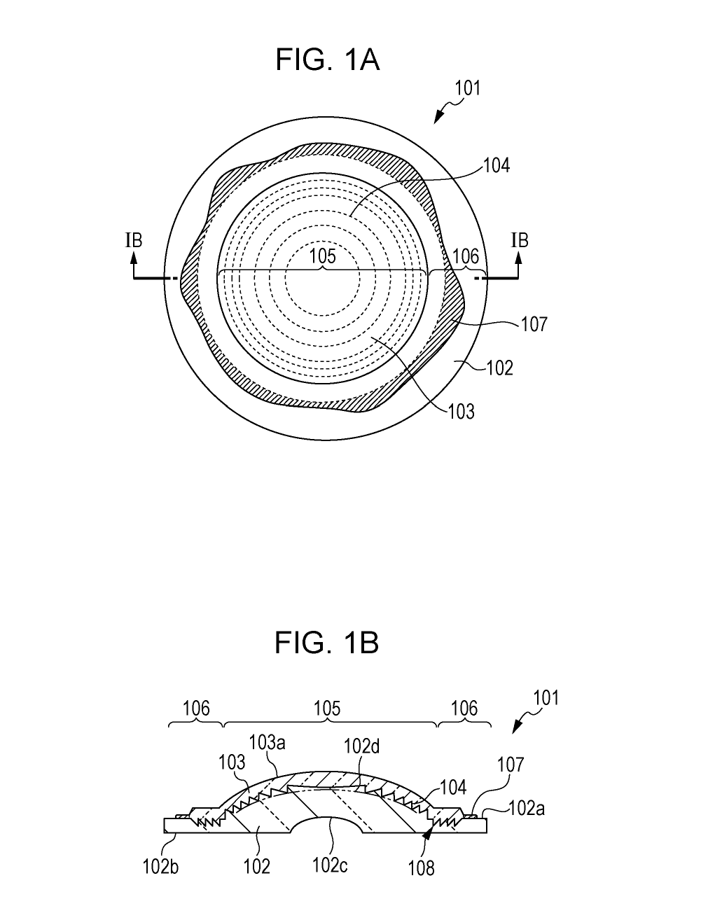

FIGS. 1A and 1B illustrate the structure of a diffractive optical element 101 according to the first embodiment. FIG. 1A is a top view of the diffractive optical element 101, and FIG. 1B is a cross-sectional view, taken along line IB-IB of FIG. 1A. As illustrated in FIG. 1B, the diffractive optical element 101 includes a base 102 and an optical adjustment layer 103. The base 102 is formed of a first optical material containing a first resin, and has a surface 102a. The surface 102a of the base 102 includes a first region 105 and a second region 106. In the first region 105, a diffraction grating 104 is provided. The optical adjustment layer 103 is formed of a second optical material containing a second resin, and is provided in contact with the first region 105 and at least a part of the second region 106 in the surface 102a of the base 102. A thin film portion 107 is provided on the outermost periphery of the optical adjustment layer 103. The film thickness of the thin film portion 107 is smaller than the maximum film thickness of a portion of the optical adjustment layer 103 in contact with the second region 106. In the first embodiment, the film thickness of the thin film portion 107 corresponds to the film thickness of the optical adjustment layer 103 from a flat face of the second region 106, where a rugged shape 108 is not provided, to a surface 103a of the optical adjustment layer 103 opposite from the base 102.

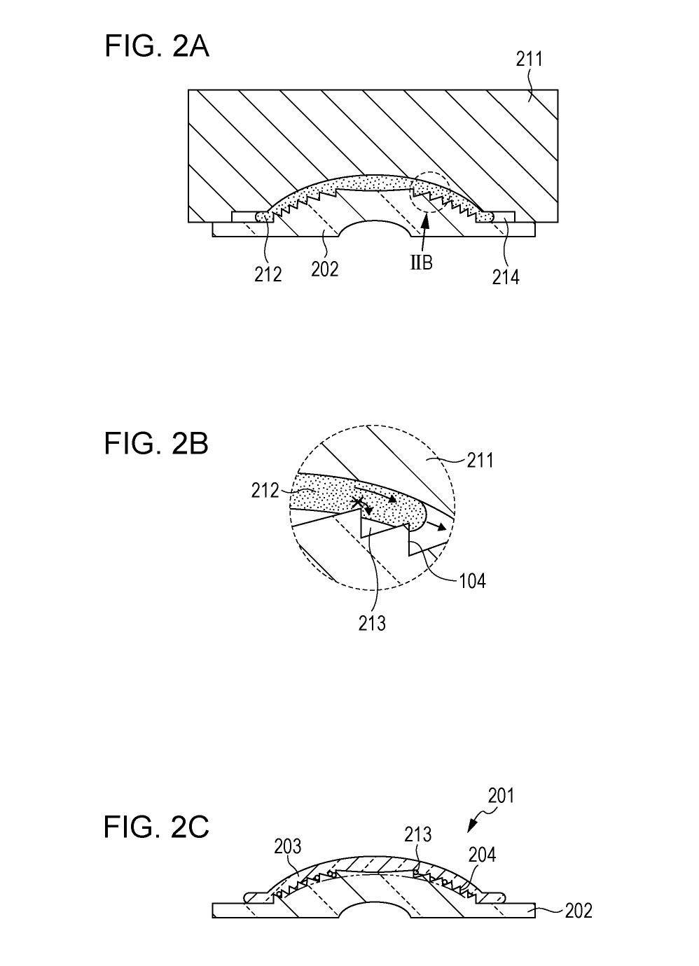

FIGS. 2A to 2C explain the problems in a diffractive optical element 201 of the related art. FIGS. 2A to 2C illustrate a state in which a raw material 212 of an optical adjustment layer 203 flows when supplied using a mold 211. FIG. 2A is an overall cross-sectional view of the diffractive optical element 201 that receives pressing force applied from the mold 211. FIG. 2B is an enlarged view of a section IIB in FIG. 2A. FIG. 2C is a cross-sectional view of the diffractive optical element 201 in a completed state.

As described above, the inventor of the present disclosure studied the control factors for the remaining state of bubbles 213 within the optical adjustment layer 203 of the phase-difference diffractive optical element 201 and/or on an interface between a base 202 and the optical adjustment layer 203. As a result, the inventor of the present disclosure has reached the idea that the bubbles 213 remain because the raw material 212 of the optical adjustment layer 203 preferentially flows along the mold 211 having a smooth curved shape when the pressing force is applied, but does not follow a diffraction grating 204.

In general, the capacity of a cavity of the mold 211 in which the raw material 212 of the optical adjustment layer 203 flows is designed to have allowance with respect to the actual supply amount of the raw material 212 so as to absorb variation in supply amount of the raw material 212. That is, the cavity of the mold 211 is not completely filled with the raw material 212 of the optical adjustment layer 203, and the raw material 212 of the optical adjustment layer 203 is released in at least a part of the cavity.

In this state, it is considered that the pressing force applied to the raw material 212 of the optical adjustment layer 203 preferentially contributes to the flow of the raw material 212 toward an open area 214 in the cavity, but does not sufficiently act on filling in the diffraction grating 204 having high flow resistance. Particularly when the viscosity of the raw material 212 of the optical adjustment layer 203 is 1000 Pa·s or less at 60° C., the raw material 212 is further released owing to the flow of pressing force applied thereto while being in late in following the shape of the diffraction grating 204. Finally, the flow of the raw material 212 of the optical adjustment layer 203 stops in a state in which bubbles 213 remain.

As for the above-described problem, the inventor of the present disclosure found that remaining of bubbles in the optical adjustment layer 103 within the effective region could be effectively restricted by forming the thin film portion 107, whose film thickness was smaller than the maximum film thickness of the optical adjustment layer 103 provided on the second region 106 of the base 102 outside the effective region of the diffractive optical element 101, in at east a part of the optical adjustment layer 103, as illustrated in FIGS. 1A and 1B.

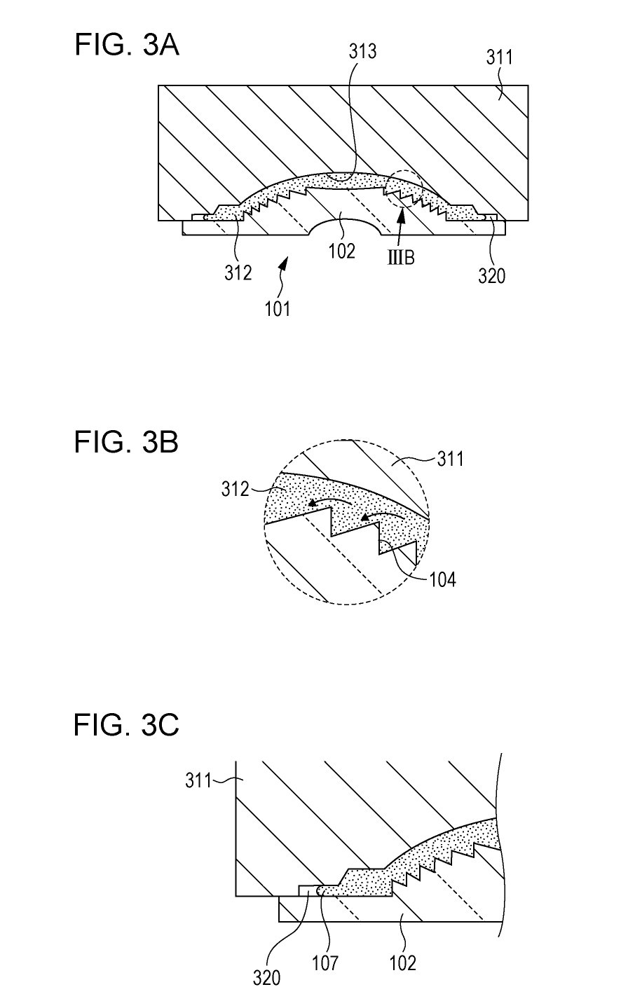

FIGS. 3A to 3C illustrate a state in which a raw material 312 of the optical adjustment layer 103 flows when it is supplied by using a mold 311 in the diffractive optical element 101 of the first embodiment illustrated in FIGS. 1A and 1B. FIG. 3A is an overall cross-sectional view of the diffractive optical element 101 that is receiving pressing force applied from the mold 311. FIG. 3B is an enlarged view of a section IIB in FIG. 3A.

As illustrated in FIG. 3A, the mold 311 has a curved shape 313 in an area corresponding to the first region 105 and a cavity area 320 for forming the thin film portion 107 in an area corresponding to the second region 106. In the cavity area 320 of the mold 311 corresponding to the thin film portion 107, the flow resistance of the raw material 312 of the optical adjustment layer 103 is higher than in the other areas. When the raw material 312 of the optical adjustment layer 103, which plastically flows owing to the application of pressing force, reaches the cavity area 320, the flow velocity is decreased by the increase in resistance, and stress in a push-back direction is produced in the raw material 312 existing on the inner side of the cavity area 320. By the action of this stress, the raw material 312 of the optical adjustment layer 103 is pushed back toward the diffraction grating 104 that is not sufficiently filled with the raw material 312, and bubbles remaining on the diffraction grating 104 are crushed and disappear. As a result, even when the material having a viscosity within the range of 1 to 1000 Pa·s, which is easily treated in production, is used as the raw material 312, it is possible to produce the diffractive optical element 101 in which bubbles do not remain in the optical adjustment layer 103.

For example, the minimum film thickness of the thin film portion 107 may be within the range of 2% to 50% of the maximum film thickness of the optical adjustment layer 103 on the first region 105 from the following viewpoint. That is, if the minimum film thickness of the thin film portion 107 exceeds 50% of the maximum film thickness on the first region 105, stress to be applied to the raw material 312 of the optical adjustment layer 103 may sometimes run short, and the raw material 312 is insufficiently filled in the diffraction grating 104. This sometimes causes remaining of bubbles in the optical adjustment layer 103. In contrast, if the minimum film thickness of the thin film portion 107 is less than 2% of the maximum film thickness on the first region 105, a crack occurs from the thin film portion 107 in the optical adjustment layer 103 at the time of mold release or in the operating environment. This may reduce the yield or long-time reliability. To produce a greater stress necessary to fill the diffraction grating 104 with the raw material 312 of the optical adjustment layer 103, the minimum film thickness of the thin film portion 107 may be within the range of 2% to 20% of the maximum film thickness of the optical adjustment layer 103 on the first region 105. Further, the minimum film thickness of the thin film portion 107 may be within the range of 2% to 50% or 20% or less of the maximum film thickness of the optical adjustment layer 103 on the second region 106.

In FIGS. 1A and 1B, the thin film portion 107 is provided on the entire outermost periphery of the optical adjustment layer 103. Considering that stress necessary to fill the raw material 312 of the optical adjustment layer 103 sufficiently acts on the entire effective region of the diffraction grating 104, for example, the thin film portion 107 is formed in a circumferential area of 30% or more of the outermost periphery of the optical adjustment layer 103. Alternatively, the thin film portion 107 may be formed in a circumferential area of 50% or more. When the thin film portion 107 is formed only in a circumferential area of less than 30%, the above-described stress is not sufficiently obtained in an area where the thin film portion 107 is not provided. As a result, bubbles can remain in the optical adjustment layer 103 on the first region 105. When the thin film portion 107 is formed in the circumferential area of 50% or more, the effect in suppressing remaining of bubbles becomes more reliable.

On the other hand, the width of the thin film portion 107 in the radial direction is not particularly limited as long as the thin film portion 107 is provided on at least a part of the second region 106 of the base 102, because the above-described stress necessary for filling in the diffraction grating 104 acts on the raw material 312 of the optical adjustment layer 103.

Next, the base 102 will be described. First, the structure of the base 102 will be described. As illustrated in FIGS. 1A and 1B, the diffraction grating 104 is provided in the first region 105 on the surface 102a of the base 102. A depth d of the diffraction grating 104 is set to be, for example, within the range of 2 to 20 μm. In the first embodiment, the surface 102a of the base 102 has a curved surface having a lens function in the first region 105. The diffraction grating 104 having a concentric shape is provided in the curved surface.

Although the cross-sectional shape of the diffraction grating 104 in the radial direction is, for example, a rectangular shape, a serrated shape, a stepped shape, a curved shape, a fractal shape, or a random shape, it is not particularly limited to these shapes. The arrangement pattern and arrangement pitch of the diffraction grating 104 are not particularly limited as long as they satisfy the characteristics required of the diffractive optical element 101.

An envelope 102d extending at the bottom of the diffraction grating 104 has, for example, a spherical shape, an aspherical shape, or a cylindrical shape. Particularly when the envelope 102d has an aspherical shape, it can correct aberration that cannot be corrected by the spherical shape. In the first embodiment, as illustrated in FIG. 1B, the envelope 102d is convex. However, the envelope 102d may be concave or flat according to the function required of the diffractive optical element 101 in the optical system.

In the first embodiment, a surface 102b of the base 102 opposite from the surface 102a is flat, and has a curve 102c whose center coincides with the center of the concentric shape of the diffraction grating 104. The curve 102c has a function of defining the optical path by refraction, and the shape of the curve 102c is determined according to the design of the entire optical system including the diffractive optical element 101. In the first embodiment, as illustrated in FIG. 1B, the curve 102c is concave. However, according to the function required of the diffractive optical element 101 in the optical system, the curve 102c may be convex, or the surface 102b may be flat without having the curve 102c.

That is, the surface of the base 102 may be spherical or aspherical so as to have the lens function, or may be flat so as not to have the lens function.

While the base 102 has the diffraction grating 104 and the optical adjustment layer 103 on only one surface 102a in the first embodiment, the one surface 102a and the other surface 102b may have their respective diffraction gratings 104. When the surfaces 102a and 102b have their respective diffraction gratings 104, the diffraction gratings 104 do not always need to be equal in the depth and cross-sectional shape. Optical adjustment layers 103 provided on both the surfaces 102a and 102b do also not always need to be equal in the material and thicknesses.

The second region 106 may be flat, or may have the rugged shape 108, as illustrated in FIG. 1B. By providing the optical adjustment layer 103 on the rugged shape 108, an anchor effect due to the increase in the contact interface area between the base 102 and the optical adjustment layer 103 is exerted, and this increases adhesion therebetween. The height of ruggedness in the rugged shape 108 may be within the range of 100 nm to 10 μm.

In FIG. 1B, the rugged shape 108 has a serrated cross-sectional shape. The cross-sectional shape of the rugged shape 108 is not particularly limited to this shape as long as it can ensure adhesion between the base 102 and the optical adjustment layer 103. The rugged shape 108 may have a rectangular, triangular, or arc-shaped cross-sectional shape, or the rugged shape 108 may be formed by, for example, roughening using embossing or sand blasting. In particular, adhesion between the base 102 and the optical adjustment layer 103 is further increased by forming the rugged shape 108 having a serrated cross-sectional shape.

Next, the material that forms the base 102 will be described. In the first embodiment, the base 102 is formed of the first optical material containing the first resin, as described above. One advantage of using the material containing resin as the first optical material is applicability of a production method with high mass productivity to production of lenses. Further, since the material containing resin can be easily subjected to fine working using molding or other working methods, the pitch of the diffraction grating 104 can be decreased. This can realize higher performance, smaller size, and lighter weight of the diffractive optical element 101. The base 102 may be formed of an optical material that does not contain resin, for example, glass.

As the first resin, a material, which has a refractive-index and a dispersion that can reduce the wavelength dependence of the diffraction efficiency at a design order m of the diffractive optical element 101 in the entire wavelength band to be used, can be selected from light-transmissive resin materials generally ally used as materials of optical elements according to the following Expression 2. That is, the material has a refractive index n1(λ) such that the relationship of Expression 2 is established between the refractive index n2 (λ) of the second optical material and the depth d of the diffraction grating 104. Such a material to be selected maintains the light transmittance, the refractive-index, and the shape of the diffraction grating 104 without being eroded by a monomer or an oligomer serving as the raw material of the second resin contained in the second optical material and/or a solvent.

$$0.9 d ≦ \vert \frac{m \cdot λ}{n 1 ( λ ) - n 2 ( λ )} \vert ≦ 1.1 d \qquad ( 2 )$$

For example, the material can be appropriately selected from polycarbonate-based resin, acrylic-based resin, alicyclic polyolefin resin, polyester resin, and silicone resin. For example, the acrylic resin is poly ethyl methacrylate (PMMA) or alicyclic acrylic resin.

A copolymer resin, a polymer alloy, or a blend polymer obtained by adding other resins to these resins, for example, in order to improve moldability or mechanical property may be used. Further, inorganic particles that adjust the optical characteristics such as the refractive index, or the dynamic characteristics, such as thermal expansibility, or dye or pigment serving as an additive for absorbing electromagnetic waves in a specific wavelength band may be added to these resins as necessary.

For example, particularly when thermoplastic resin, such as polycarbonate-based resin, alicyclic olefin resin, or polyester-based resin, is used as the first resin, injection molding that is particularly excellent in productivity can be adopted in production of the base 102. In this case, the refractive index of the first resin is limited to some extent, and reduction of the diffraction grating depth d determined by Expression 2 is also limited. However, according to the structure of the first embodiment, even when the diffraction grating depth d is large, the diffraction grating 104 can be sufficiently filled with the optical adjustment layer 103. For this reason, it is possible to provide the diffractive optical element that is excellent in optical characteristics and long-term reliability.

Next, the optical adjustment layer 103 will be described in detail. As described above, the optical adjustment layer 103 is provided to reduce the wavelength dependence of the diffraction efficiency in the diffractive optical element 101. When a phase-difference type diffraction grating is structured by forming the optical adjustment layer 103 on the base 102 having the diffraction grating 104 in at least one surface thereof, such diffraction grating depth d that the first-order diffraction efficiency of the lens is 100% at a certain wavelength λ is given by Expression 1. When the right side of Expression 1 becomes substantially fixed in a certain wavelength band, the first-order diffraction efficiency does not have the wavelength dependence in the wavelength band. For that purpose, the first optical material of the base 102 and the second optical material of the optical adjustment layer 103 are formed by a combination of a material having low refractive index and high dispersion and a material having high refractive index and low dispersion.

In particular, by using such a combination of a first optical material and a second material that the diffraction grating depth d in Expression 1 is substantially fixed in the entire visible light region within the wavelength range of 400 to 700 nm, the diffractive optical element 101 in which the first-order diffraction efficiency does not depend on the wavelength in the visible light region is realized. When such a diffractive optical element 101 is used, for example, as a lens for imaging, the occurrence of flare or the like due to diffraction light of the unnecessary order is suppressed, and this improves image quality. It is actually difficult to make the diffraction grating depth d in Expression 1 strictly fixed in the entire visible light region. As long as the refractive indices of the first optical material and the second optical material satisfy Expression 2, the diffractive optical element 101 of the first embodiment of the present disclosure can obtain sufficient optical characteristics.

There is no problem in the optical characteristics of the optical adjustment layer 103 as long as the diffraction grating 104 is completely filled with the optical adjustment layer 103 to form a smooth surface shape. If the film thickness of the optical adjustment layer 103 extremely increases, when it is used as a lens, coma aberration and the like increases. Moreover, the influence of curing shrinkage of the second optical material in formation of the optical adjustment layer 103 increases, and this makes control of the surface shape difficult, and deteriorates the light collecting property. From the above-described viewpoint, for example, the maximum film thickness of the optical adjustment layer 103 may be more than or equal to the diffraction grating depth d and less than or equal to 200 μm, and more particularly, may be more than or equal to the diffraction grating depth d and less than or equal to 100 μm. The maximum film thickness of the optical adjustment layer 103 corresponds to the film thickness from the surface 103a of the optical adjustment layer 103 opposite from the base 102 to the bottom of the diffraction grating 104.

For example, the surface 103a of the optical adjustment layer 103 opposite from the base 102 is formed to have the same shape as that of the envelope 102d extending at the bottom of the diffraction grating 104. In this case, for example, chromatic aberration and curvature of field are corrected in a well-balanced manner by the combination of the refracting action and the diffracting action, and it is possible to obtain a lens having high imaging performance and improved MTF (Modulation Transfer Function).

The optical adjustment layer 103 is formed to cover not only the first region 105 on the surface 102a of the base 102, but also at least a part of the second region 106 in order to suppress deterioration of the optical characteristics due to shortage of the supply amount of the raw material of the optical adjustment layer 103 and/or floating or peeling from the base 102.

Next, the material that forms the optical adjustment layer 103 will be described. In the first embodiment, the optical adjustment layer 103 is formed of the second optical material containing the second resin. As described above, the second optical material is selected from materials having refractive index that can satisfy Expression 2, for example, in consideration of non-erodibility with respect to the first region 105 in the surface 102a of the base 102, shape controllability, ease of handling in the production process, and durability.

While the kind of the second resin is not particularly limited, for example, the second resin can be (meth)acrylic resin such as poly(methyl methacrylate), acrylate, methacrylate, urethane acrylate, epoxy acrylate, or polyester acrylate, epoxy resin, oxetane resin, ene-thiol resin, polyester resins such as polyethylene terephthalate, polybutylene terephthalate, and polycaprolactone, polystyrene resin such as polystyrene, olefin resin such as polypropylene, polyamide resin such as nylon, polyimide resins such as polyimide or polyetherimide, polyvinyl alcohol, butyral resin, vinyl acetate resin, or alicyclic polyolefin resin. Further, a mixture or a copolymer of these resins may be used, or those obtained by denaturing these resins may be used.

Among these resins, especially, when energy curable resin, such as thermosetting resin or energy-ray curable resin, is used as the second resin, the process for forming the optical adjustment layer 103 is facilitated. Specifically, examples of the second resin are acrylate resin, methacrylate resin, epoxy resin, oxetane resin, silicone resin, and ene-thiol resin.

It is difficult to select a combination of resin materials that is greatly different in the refractive index and dispersion, compared with glass, because of its composition. That is, there are a few combinations of the first optical material containing the first resin and the second optical material containing the second resin that satisfy Expression 2. To overcome this problem, a composite material in which inorganic particles are dispersed in a resin serving as a matrix material can be used as the second optical material.

The refractive index and Abbe number of the second optical material can be finely adjusted by the kind, amount, or size of the inorganic particles dispersed in the matrix material. This can increase the number of candidates of combinations of the first optical material and the second optical material that satisfy Expression 2, and can make the difference in refractive index from the base 102 larger than when the resin is used alone. For this reason, as is clear from Expression 2, the diffraction grating depth d can be decreased, the film thickness necessary as the optical adjustment layer 103 is decreased, and the light transmitting property is improved. Moreover, light to pass through a side face portion of the diffraction grating 104 is reduced. Further, since the first optical material and the second optical material can more accurately satisfy Expression 2, the diffraction efficiency of the diffractive optical element 101 can be enhanced further. According to the above results, the occurrence of flare and deterioration of the contrast on a taken image are suppressed. Still further, materials having various physical properties can be used as the second resin, and this expands the range of selection of the composition of the second optical material that satisfies both the optical characteristics, and mechanical characteristics, environment resistance, or ease of handling in the production process.

When the base 102 is formed of the first optical material containing the first resin and the optical adjustment layer 103 is formed of the composite material serving as the second optical material, the refractive index of the organic particles is generally higher than that of the resin. For this reason, the number of materials to be selected as the inorganic particles, the first resin, and the second resin is increased by making adjustment so that the composite material exhibits high refractive index and low dispersion.

The refractive index of the second optical material formed of the composite material can be estimated from the refractive indices of the second resin serving as the matrix material and the inorganic particles, for example, according to the Maxwell-Garnet theory expressed by the following Expression By estimating the refractive indices for the d-line (587.6 nm), the F-line (486.1 nm), and the C-line (656.3 nm) according to Expression 3, the Abbe number of the composite material can also be estimated. Conversely, the mixture ratio of the second resin serving as the matrix material and the inorganic particles may be determined by the estimation based on the theory.

$${n}_{com λ}^{2} = \frac{{n}_{p λ}^{2} + 2 {n}_{m λ}^{2} + 2 P ( {n}_{p λ}^{2} + 2 {n}_{m λ}^{2} )}{{n}_{p λ}^{2} + 2 {n}_{m λ}^{2} - P ( {n}_{p λ}^{2} + 2 {n}_{m λ}^{2} )} {n}_{m λ}^{2} \qquad ( 3 )$$

In Expression 3, n_{comλ} represents the average refractive index of the composite material at a specific wavelength λ, and n_{pλ} and n_{mλ} represent the refractive index of the inorganic particles and the refractive index of the second resin serving as the matrix material at the wavelength λ, respectively. In Expression 3, P represents the volume ratio of the inorganic particles to the entire composite material. When the inorganic particles absorb light or the inorganic particles contain metal, the refractive indices in Expression 3 are calculated as complex refractive indices.

As described above, when the composite material is used as the second optical material, it is required to have high refractive index and low dispersion. Accordingly, the inorganic particles to be dispersed in the composite material may also be mainly composed of a material having low dispersion, that is, high Abbe number. For example, the inorganic particles can be mainly composed of at least one oxide selected from the group consisting of zirconium oxide (Abbe number: 35), yttrium oxide (Abbe number: 34), lanthanum oxide (Abbe number: 35), alumina (Abbe number: 76), silica (Abbe number: 68), hafnium oxide (Abbe number: 32), YAG (yttrium aluminum garnet) (Abbe number: 52), and scandium oxide (Abbe number: 27). Alternatively, a composite oxide of these oxides may be used. Further, in addition to these inorganic particles, for example, inorganic particles having high refractive index, represented by titanium oxide and zinc oxide, may coexist as long as the refractive index of the second optical material serving as the composite material satisfies Expression 2 in the wavelength band to be used.

The median particle diameter of the inorganic particles in the composite material is set to be, for example, within the range of 1 to 100 nm. When the median particle diameter is 100 nm or less, it is possible to reduce loss due to Rayleigh scattering and to increase transparency of the optical adjustment layer 103. Further, when the median particle diameter is 1 nm or more, it is possible to reduce the influence, for example, of light emission due to the quantum effect. According to the need, the composite material may contain a dispersant for improving dispersion of the inorganic particles, or an additive such as polymerization initiator or a leveling agent.

When the optical adjustment layer 103 is formed using the composite material as the second optical material, a solvent may coexist in the formation process. The solvent to be contained in the composite material is used to facilitate dispersion of the inorganic particles in the second resin and to adjust the viscosity for improved handling. The kind of the solvent is selected to satisfy the required characteristics such as dispersion of the inorganic particles, solubility of the resin serving as the matrix material in the composite material, and ease of handling in the production process. As an example of the ease of handling in the production process, for example, wettability to the base or ease of drying expressed by the boiling point or the vapor pressure is given.

According to the diffractive optical element of the first embodiment having the above-described structure, even when a low-viscosity raw material of the optical adjustment layer that is easy to treat in the production process is used, the action of the thin film portion provided in at least a part of the optical adjustment layer restricts bubbles from remaining within the optical adjustment layer and/or on the interface between the base and the optical adjustment layer in the effective region of the diffractive optical element. As a result, in the obtained diffractive optical element, the optical characteristics are not deteriorated by scattering of incident light due to the bubbles. Further, the optical adjustment layer can be prevented from being cracked from the remaining bubbles with environmental change or long-term use. Still further, these can enhance long-term reliability of the diffractive optical element.

### Second Embodiment

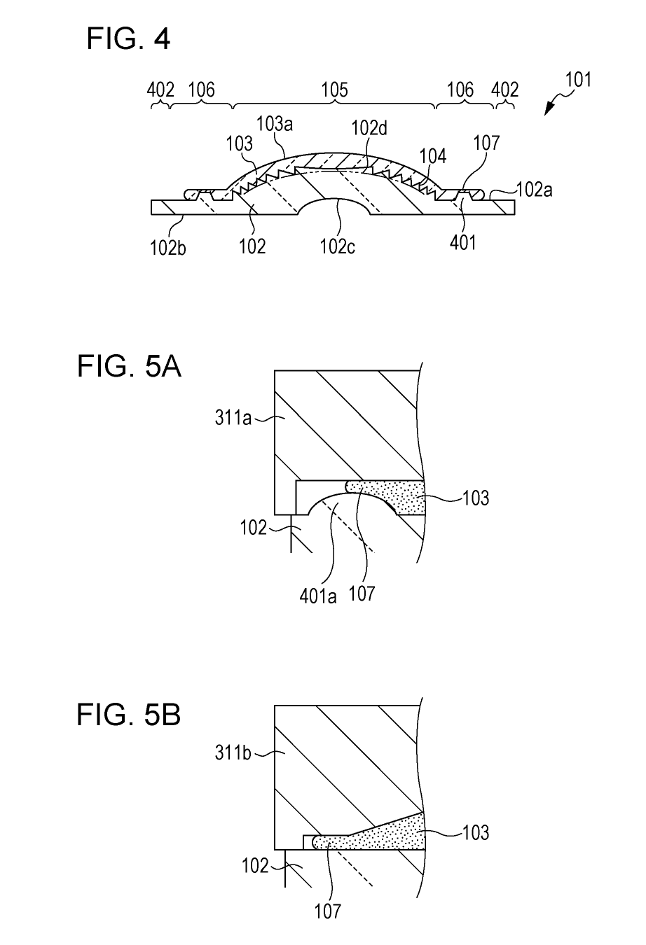

In the first embodiment, as illustrated in FIGS. 1A and 1B, the recess is provided as the thin film portion 107 in the surface shape of the optical adjustment layer 103. However, the shape of the thin film portion 107 does not always need to be limited to this shape. For example, as illustrated in FIG. 4, a projecting portion 401 corresponding to a thin film portion 107 may be provided in a part of a surface of a second region 106 of a base 102.

While a connecting portion between the thin film portion 107 and the surrounding portion of the optical adjusting portion 103 has a stepped cross-sectional shape in the radial direction in FIGS. 1A, 1B, and 4, the cross-sectional shape does not always need to be limited thereto. FIGS. 5A and 5B are enlarged views of a part of the diffractive optical element to which pressing force is applied from molds 311a and 311b. For example, as illustrated in FIGS. 5A and 5B, the radial cross section of the connecting portion between the thin film portion 107 and the surrounding portion of the optical adjustment layer 103 may be arc-shaped or may be shaped like a slope having no clear stepped portion.

The film thickness of the optical adjustment layer 103 except for the hin film portion 107 on the second region 106 is not particularly limited. The film thickness may be substantially constant, or may be appropriately made uneven for the purpose of increasing adhesion or receiving an excessive quantity of raw material of the optical adjustment layer 103.

Further, as illustrated in FIG. 4, the base 102 may include a third region 402 on an outer side of the second region 106 on a surface 102a. In this case, at least a part of the third region 402 may be flat. The third region 402 can be used as a holding portion when mounting the diffractive optical element 101 in a module. Further, the third region 402 may be used as a reference face when ensuring mounting accuracies of the components of the module and adjusting the focus position.

When the third region 402 is used as the reference face in mounting, for example, a surface roughness Ra of the third region 402 is set at 1.6 μm or less. The shape and size of the third region 402 are appropriately determined by, for example, the requirements requested by a module or a device in which the diffractive optical element 101 is to be incorporated, and are not particularly limited in the second embodiment.

### Third Embodiment

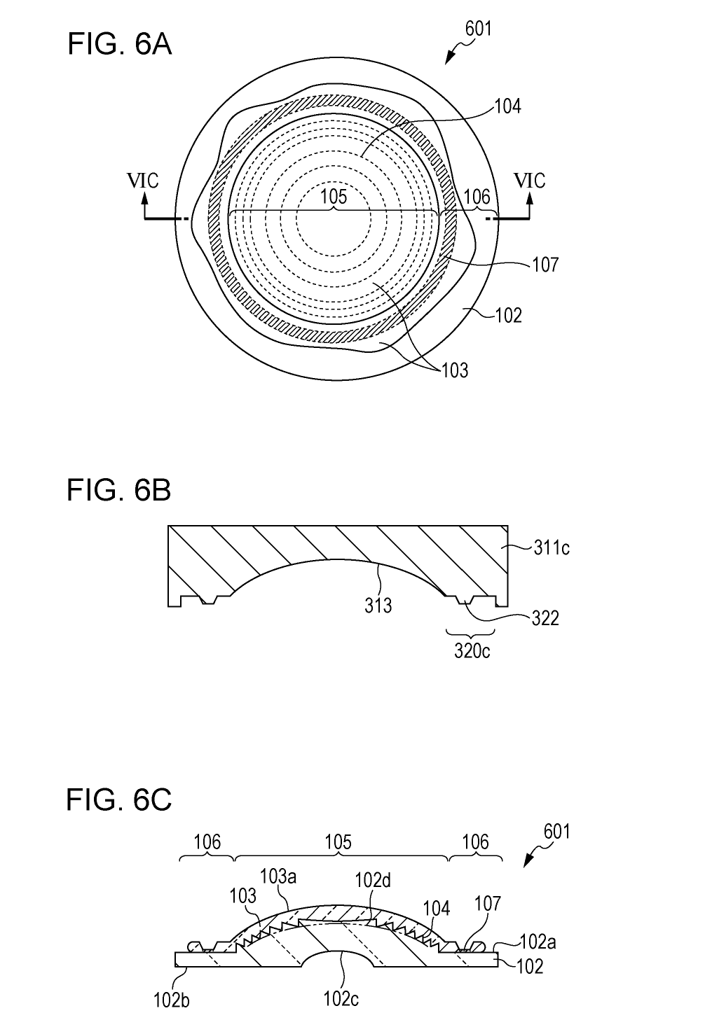

A diffractive optical element according to a third embodiment will be described below. FIGS. 6A to 6C illustrate the structure of a diffractive optical element 601 according to the third embodiment. FIG. 6A is a top view of the diffractive optical element 601, FIG. 60 is a cross-sectional view taken along line VIC-VIC of FIG. 6A, and FIG. 6B is a cross-sectional view of a mold 311c, and corresponds to FIG. 6C.

As illustrated in FIGS. 6A to 6C, the diffractive optical element 601 includes a base 102 and an optical adjustment layer 103. The diffractive optical element 601 is different from the first embodiment in that a thin film portion 107 concentric with a first region 105 of the base 102 is provided in a part of the optical adjustment layer 103 and in that the optical adjustment layer 103 is also provided on an outer periphery of the thin film portion 107. Other structures of the diffractive optical element 601 are the same as those of the first embodiment.

Similarly to the first embodiment, in the diffractive optical element 601 of the third embodiment, when a raw material 312 of the optical adjustment layer 103 reaches a projecting portion 322 provided in a cavity area 320c of the mold 311c to correspond to the thin film portion 107, the flow velocity is decreased by the increase in resistance, and stress in a push-back direction acts on a part of the raw material 312 of the optical adjustment layer 103 existing on the inner side of the cavity area 320c. The action of this stress allows production of the diffractive optical element 601 having no remaining bubbles within the optical adjustment layer 103.

In the third embodiment, the optical adjustment layer 103 is also provided on the outer periphery of the thin film portion 107. The part of the optical adjustment layer 103 on the outer periphery absorbs variation in supply amount of the raw material of the optical adjustment layer 103. This allows reliable formation of the thin film portion 107.

For example, the width of the thin film portion 107 may be 0.02 mm or more or 0.05 mm or r yore in order to exert the flow resistance to the raw material 312 of the optical adjustment layer 103. The upper limit of the width is determined by the sizes or shapes of the entire diffractive optical element 601 and the effective region, and is not particularly limited.

According to the diffractive optical element 601 of the third embodiment having the above-described structure, similarly to the first embodiment, even when a low-viscosity raw material that is easy to treat in the production process is used for the optical adjustment layer 103, the action of the thin film portion 107 provided ire at least a part of the optical adjustment layer 103 restricts bubbles from remaining within the optical adjustment layer 103 and/or on an interface between the base 102 and the optical adjustment layer 103 in the effective region of the diffractive optical element 601. As a result, it is possible to obtain the diffractive optical element that is excellent in optical characteristics and long-term reliability.

### Fourth Embodiment

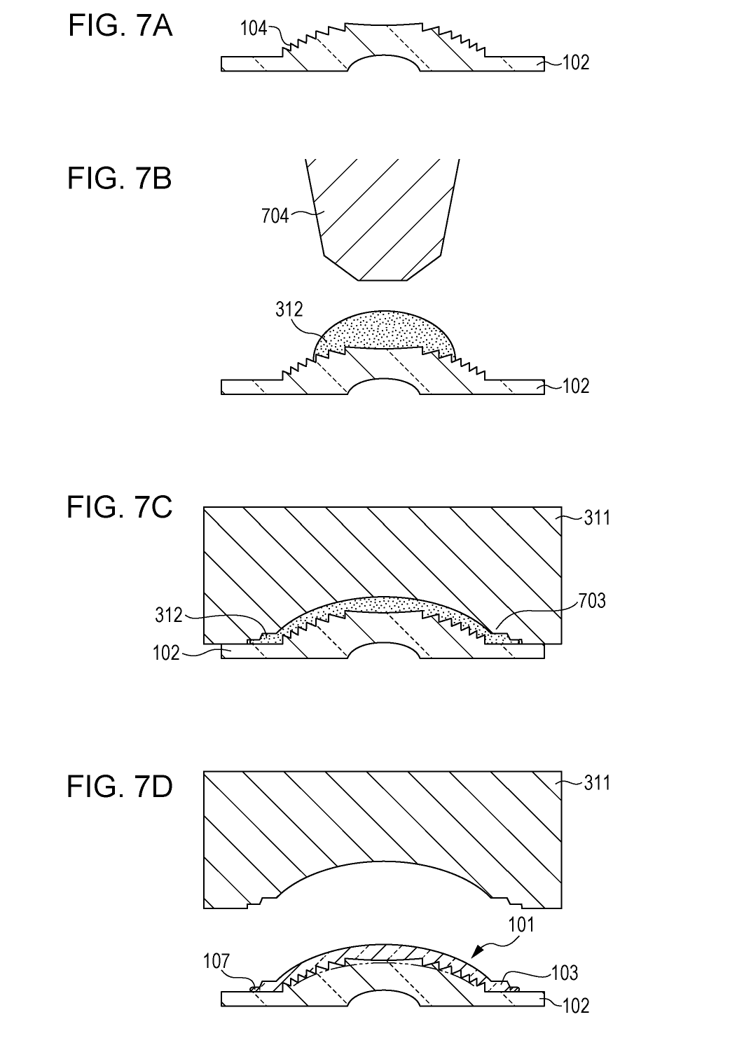

Next, an example of a method for producing the diffractive optical element of the first embodiment will be described with reference to FIGS. 7A to 7D. The following production method is similarly applicable to the second and third embodiments.

First, as illustrated in FIG. 7A, a base 102 having a diffraction grating 104 on its surface 102a is prepared. For example, the base 102 is formed of a first optical material containing a first resin and is molded to have the diffraction grating 104 on the surface 102a. As described above, the surface 102a of the base 102 may be spherical or aspherical to have a lens function, or may be flat. The diffraction grating 104 in a first region 105, and a projecting portion 401 and/or a rugged shape 108, which is provided in a second region 106 as necessary, can be formed by a method in accordance with the shapes thereof and the material of the base 102, for example, by means of molding, transfer, cutting, grinding, polishing, laser machining, or etching.

When the base 102 is formed of the first optical material containing the first resin, it is quite easy to integrally form the base 102 having the diffraction grating 104, and the projecting portion 401 and/or the rugged shape 108 by using a molding process such as injection molding. This can greatly enhance productivity. Alternatively, the base 102 having the diffraction grating 104 may be integrally formed by a molding process, and only the projecting portion 401 and/or the rugged shape 108 on the second region 106 may be formed by cutting using a cutting tool or the like. Since the base 102 is formed of the first optical material containing the first resin, the projecting portion 401 and/or the rugged shape 108 can be easily formed even by such a method.

When the optical adjustment layer 103 is formed by molding in the diffractive optical element 101 of the first embodiment of the present disclosure, as will be described later, it is considered that pressing force to be applied to a part of a raw material 312 of an optical adjustment layer 103 on the inner side of a thin film portion 107, that is, on the side closer to the optical axis increases during formation of the thin film portion 107. At this time, stress with which the raw material 312 of the optical adjustment layer 103 is pressed against a mold 311 also increases. As a result, stress required for release from the mold 311 increases, that is, mold releasability decreases, compared with a case in which the thin film portion 107 is not formed. If adhesion between the base 102 and the optical adjustment layer 103 is low, the optical adjustment layer 103 peels off the base 102 during release, and this deteriorates the optical characteristics and yield of the diffractive optical element 101. Hence, in the diffractive optical element 101 of the first embodiment of the present disclosure, adhesion between the base 102 and the optical adjustment layer 103 may be increased by forming the rugged shape 108 on the second region 106 of the base 102.

When the base 102 is integrally formed by molding, for example, the depth of the diffraction grating 104 is set to be 20 μm or less so that mold working is easy and the diffraction grating 104 has high working accuracy. If the depth of the diffraction grating 104 exceeds several tens of micrometers, at is difficult to work the mold with high accuracy. This is because, while the shape of the mold is generally formed by cutting using a cutting tool, if the diffraction grating 104 is deep, the working amount increases, and the tip of the cutting tool is worn. This deteriorates the working accuracy as the working proceeds. Further, if the diffraction grating 104 is deep, it is difficult to ensure a short pitch. This is because, when the diffraction grating 104 is deep, there is a need to work the mold with a cutting tool having a large radius of curvature at the tip, and as a result, the pitch is needed to be increased to some extent for working of the diffraction grating 104. From these, flexibility in design decreases as the depth of the diffraction grating 104 increases, and the aberration reduction effect is not obtained by adoption of the diffraction grating 104.

Next, as illustrated in FIG. 7B, a raw material 312 of the optical adjustment layer is supplied on the prepared base 102. In the fourth embodiment, a raw material 312 of the optical adjustment layer containing a second resin material is prepared, and is supplied on the base 102 to completely cover the diffraction grating 104 and to form a thin film portion 107 on the second region 106 of the base 102.

A method for providing the raw material 312 of the optical adjustment layer on the base 102 is appropriately selected from known coating processes according to shape accuracy of the optical adjustment layer 103 determined by the material characteristics, such as viscosity, and the optical characteristics required of the diffractive optical element 101. Specifically, for example, coating using a liquid injection nozzle such as a dispenser, jet coating such as an inkjet method, squeezing coating such as screen printing or pad printing, various molding methods using a transfer or mold, and rotary coating such as spin coating, can be used. These processes may be combined appropriately. Among the above-described processes, especially, any of molding, pad printing, and screen printing, or a combination of these processes may be used from the viewpoints of sufficiently filling the diffraction grating 104 by the application of pressing force and defining a smooth surface shape of the optical adjustment layer 103.

In the fourth embodiment, after the raw material 312 of the optical adjustment layer is supplied on the base 102 by using a dispenser 704, as illustrated in FIG. 7B, a mold 311 is set on the base 102, as illustrated in FIG. 7C. Conversely to the example of FIG. 7B, the base 102 may be set on the mold 311 after the raw material 312 of the optical adjustment layer is supplied on the mold 311.

When the raw material 312 of the optical adjustment layer is provided by molding using the mold 311, since the mold 311 has a projecting portion 703 in a part opposed to the second region 106 of the base 102, a thin film portion 107 can be formed in the optical adjustment layer 103. The base 102 may have a projecting portion 401 or 401a, and a corresponding thin film portion 107 may be formed.

For example, the viscosity of the raw material 312 of the optical adjustment layer 103 is set at 1000 Pa·s or less at 60° C. In this case, suppression of remaining of bubbles within the optical adjustment layer 103 and/or on the interface between the base 102 and the optical adjustment layer 103 is markedly observed, and high productivity can be expected. If the viscosity of the raw material 312 at 60° C. exceeds 1000 Pa·s, supply of the raw material 312 on the base 102 is difficult, and this may increase the tact time or may decrease the yield. Further, for example, the lower limit of the viscosity of the raw material 312 is set at 1 Pa·s or more at 60° C. If the optical adjustment layer 103 is formed of the raw material 312 having a viscosity of less than 1 Pa·s at 60° C., trouble may occur, that is, imaging is not achieved even when an image is taken with a lens having the optical adjustment layer 103 mounted therein. In this case, bubbles can remain within the optical adjustment layer 103 and/or on the interface between the base 102 and the optical adjustment layer 103.

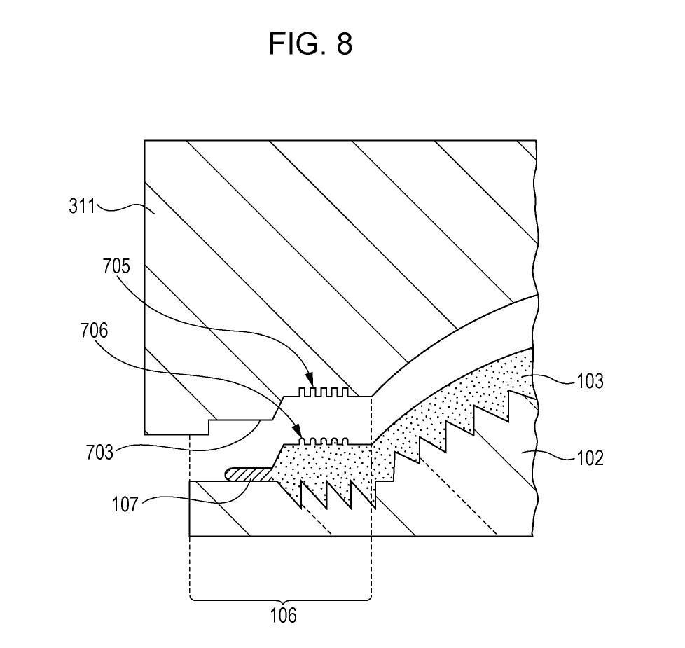

When the mold 311 is produced, as illustrated in FIG. 8, in addition to the projecting portion 703 corresponding to the thin film portion 107, a fine rugged portion 705 that is finer than the thin film portion 107 may also be formed in at least a part of an area corresponding to the second region 106 of the base 102. When the raw material 312 of the optical adjustment layer is provided by molding, as described above; mold releasability sometimes decreases with formation of the thin film portion 107. By forming the fine rugged portion 705 in at least a part of the area of the mold 311 corresponding to the second region 106 of the base 102, the contact area between the raw material of the second optical material and the f gold 311 is reduced. As a result, in the diffractive optical element of the embodiment of the present disclosure, in which the thin film portion 107 is provided, release from the mold 311 is easy, and the optical characteristics or yield can be restricted from being deteriorated by peeling of the optical adjustment layer 103.

The shape of the fine rugged portion 705 is not particularly limited as long as it achieves the above object. For example, the fine rugged portion 705 can adopt an embossed shape, rectangular grooves, serrated grooves, or pits. By arranging rectangular grooves or serrated grooves concentrically or helically around the optical center, the fine rugged portion 705 can be formed by cutting together with the aspherical shape and the projecting portion 703 corresponding to the effective region when the mold 311 is produced.

If ruggedness of the fine rugged portion 705 is coarser than the thin film portion 107, the function of the thin film portion 107 is not found. Although the depth and pitch of the ruggedness is not particularly limited as long as the fine rugged portion 705 is finer than the thin film portion 107, for example, in the case of the grooves, the above-described releasability improving effect can be exerted by setting the depth within the range of 1 to 15 μm and setting the pitch within the range of 1 to 30 μm.

When an energy curable resin is used as a second resin after that, the raw material 312 of the optical adjustment layer containing this material is cured. By curing the raw material of the second resin, the raw material 312 of the optical adjustment layer is entirely cured to form an optical adjustment layer 103. Thus, as illustrated in FIG. 7D, a diffractive optical element 101 in which the optical adjustment layer 103 is provided on the surface of the base 102 having the diffraction grating 104 is completed.

As the curing method, for example, a heat curing process or an energy-ray irradiation process can be used in accordance with the kind of the second resin to be used. Energy rays used in the curing process are, for example, ultraviolet rays, visible rays, infrared rays, or electron rays. When performing ultraviolet curing, a photopolymerization initiator may be added to the raw material 312 of the optical adjustment layer beforehand. When performing electron-ray curing, a photopolymerization initiator is normally not used.

According to the embodiments of the present disclosure, even when the raw material of the optical adjustment layer having a viscosity such as to be easily treated in the production process is used, bubbles are restricted from remaining within the optical adjustment layer and/or on the interface between the base and the optical adjustment layer in the effective region of the diffractive optical element. Therefore, the raw material of the optical adjustment layer can be easily provided on the base, and the optical adjustment layer can be prevented from being cracked from remaining bubbles during release from the mold. This realizes a high-productivity production method for the diffractive optical element.

### EXAMPLES

A description ill be given below of results of estimation of characteristics of a produced diffractive optical element that was made to confirm the advantages of the embodiments of the present disclosure.

### First Example

A diffractive optical element according to a first example was produced as follows. First, an aspherical lens formed of bisphenol A polycarbonate resin (diameter: 6.0 mm, thickness: 0.8 mm, d-line refractive index: 1.585, Abbe number: 30) and having, on one surface, a zone-shaped diffraction grating 104 with a depth of 15 μm was formed as a base 104 by injection molding. The effective radius of a lens part was 1.4 mm, and the number of zones was sixteen. The minimum ring pitch was 15 μm, and the paraxial R (radius of curvature) of a diffraction surface was 1.37 mm.

Next, a raw material 312 of an optical adjustment layer was produced. After an isopropyl alcohol dispersion liquid (total solid content: 35.6 wt %) of an acrylate monomer mixture (d-line refractive index: 1.530, Abbe number: 50, density after curing: 1.14 g/cm³), an photopolymerization initiator (IRGACURE) (registered trademark) 184 (3 wt % with respect to the monomer mixture), and a zirconium oxide filler (median particle diameter: 6 nm) was prepared, isopropyl alcohol was removed at reduced pressure by a rotary evaporator at 70° C. and for thirty minutes. The viscosity of an obtained raw material of a second optical material before curing was 80 Pa·s (25° C.) and 2.7 Pa·s (60° C.). The d-line refractive index was 1.626, and the Abbe number was 46.

Next, a mold 311 on which the raw material 312 was to be supplied was produced. An aspherical shape corresponding to a first region of a base, a shape corresponding to a second region of the base, and a projecting portion 703 corresponding to a thin film portion 107 of an optical adjustment layer 103 were formed on a mold base, in which STAVAX (registered trademark) was plated with nickel (film thickness 100 by cutting using a diamond cutting tool. The maximum film thickness of the aspherical shape was 30 μm. The projecting portion 703 was formed concentrically with the aspherical shape. The distance from the outermost end of the aspherical shape to the innermost end of the projecting portion 703 was 0.6 mm, the width of the projecting portion 703 was 0.35 mm, and the height of the projecting portion 703 was 30 μm.

The raw material 312 of the optical adjustment layer was heated to 30° C., and was supplied by 0.3 μL on almost the center portion of the first region 105 of the base 102 by using a dispenser. The time required for supplying the raw material 312 of the optical adjustment layer was 1 second or less. Subsequently, the mold 311 was set opposed to the supplied raw material 312 of the optical adjustment layer, and the raw material 312 of the optical adjustment layer was molded into an aspherical shape with pressure (6 kgf). After that, the molded raw material 312 of the optical adjustment layer was cured by ultraviolet irradiation (illuminance: 500 mW/cm², integrated amount of light: 15000 mJ/cm²) so as to form an optical adjustment layer 103. After that, a diffractive optical element 101 having the structure illustrated in FIGS. 1A and 1B was obtained by releasing the optical adjustment layer 103 from the mold 311.

In the obtained diffractive optical element 101, the thin film portion 107 was formed so that the outermost peripheral portion of the optical adjustment layer 103 reached the projecting portion 703 of the mold 311. Observing the cross section of the diffractive optical element 101 with an optical microscope, the film thickness of the thin film portion 107 was 3 μm.

In the diffractive optical element 101 of the first example, bubbles were not observed in the optical adjustment layer 103 within the effective region. When an image was taken using a lens (VGA correspondence, F 2.8) in which the diffractive optical element 101 was mounted, remarkable occurrence of flare light and deterioration of the contrast resulting from stray light were not found, and a good image was obtained. Further, when the diffractive optical element 101 was subjected to a high-temperature and high-humidity test (85° C., 85% RH 1000 hours), the optical adjustment layer 103 was not cracked, and high environment resistance was exhibited.

### Second Example

A diffractive optical element 601 according to a second example was produced by a method similar to the method for the first example. The second example is different from the first example in that the width of a projecting portion 703 of a mold 311 is set at 0.2 mm and in that an outermost peripheral portion of an optical adjustment layer 103 after releasing reaches a portion on an outer side of a thin film portion 107. Observing the cross section of the diffractive optical element 601 of the second example with an optical microscope, the film thickness of the thin film portion 107 was 5 μm.

In the diffractive optical element 601 of the second example, bubbles were not observed in the optical adjustment layer 103 within the effective region. When an image was taken using a lens in which the diffractive optical element 601 was mounted, remarkable occurrence of flare light and deterioration of the contrast resulting from stray light were not found, and a good image was obtained. Further, when the diffractive optical element 601 was subjected to a high-temperature and high-humidity test (85° C., 85% RH, 1000 hours), the optical adjustment layer 103 was not cracked, and high environment resistance was exhibited.

### First Comparative Example

In a diffractive optical element according to a first comparative example, the supply amount of a raw material of an optical adjustment layer is 0.1 μL. The first comparative example is different from the first example in that a thin film portion is not provided.

In the diffractive optical element of the first comparative example, a plurality of bubbles having a diameter more than 10 μm were confirmed in the optical adjustment layer within the effective region. When an image was taken using a lens in which the diffractive optical element of the first comparative example was mounted, incident light was scattered by the bubbles, and flare occurred. When a high-temperature and high-humidity test (85° C., 85% RH) was conducted, the optical adjustment layer was cracked from the bubbles after 200 hours elapsed.

### Second Comparative Example

In a diffractive optical element according to a second comparative example, the viscosity of a raw material of an optical adjustment layer is 700 Pa·s (60° C.) before curing, the heating temperature is 60° C. when a raw material of a second optical material is supplied on a base, and the supply amount of the raw material of the optical adjustment layer is 0.1 μL. The second comparative example is different from the first example in that a thin film portion is not provided. The time required for the step of supplying the raw material of the second optical material by 0.1 μL on a base was five seconds.

In the diffractive optical element of the second comparative example, similarly to the first comparative example, a plurality of bubbles having a diameter more than 10 μm were observed in the optical adjustment layer within an effective region. When an image was taken using a lens in which the diffractive optical element of the second comparative example was mounted, incident light was scattered by the bubbles, and flare occurred.

The following embodiments have been disclosed in the above description.

(1) A diffractive optical element 101, 601 of the present disclosure includes a base 102 having, on a surface, a first region 105 with a diffraction grating 104 and a second region 106 located on an outer side of the first region 105, and an optical adjustment layer 103 provided on the surface to be in contact with the first region 105 and at least a part of the second region 106. A thin film portion 107 having a film thickness smaller than a maximum film thickness of a portion of the optical adjustment layer 103 in contact with the second region 106 is provided in at least a part of the portion of the optical adjustment layer 103 in contact with the second region 106.

According to the feature of the present disclosure, it is possible to provide the diffractive optical element in which bubbles are restricted from remaining within the optical adjustment layer 103 and/or on an interface between the base 102 and the optical adjustment layer 103 and which is excellent in productivity and long-term reliability.

By restricting the bubbles from remaining, scattering of incident light by the bubbles is suppressed. Thus, it is possible to obtain the diffractive optical element having good optical characteristics such that a ghost and flare do not occur or the contrast is not deteriorated. Further, the raw material of the optical adjustment layer is easily deposited on the base, and the optical adjustment layer can be prevented from being cracked from the remaining bubbles when the diffractive optical element is released from a mold. Hence, it is possible to realize a high-productivity production method for the diffractive optical element. Still further, since the optical adjustment layer can be prevented from being cracked from the remaining bubbles owing to the environmental change and long-term use, long-term reliability of the diffractive optical element can be enhanced.

(2) The thin film portion 107 may have a film thickness that is within a range of 2% to 50% of the maximum film thickness of the portion of the optical adjustment layer 103 in contact with the second region 106.

According to this feature, bubbles can be more markedly restricted from remaining within the optical adjustment layer 103 and/or on the interface between the base 102 and the optical adjustment layer 103.

The thin film portion 107 may have a film thickness that is within a range of 2% to 20% of the maximum film thickness of the portion of the optical adjustment layer 103 in contact with the second region 106.

According to this feature, bubbles can be more markedly restricted from remaining within the optical adjustment layer 103 and/or on the interface between the base 102 and the optical adjustment layer 103.

(3) The thin film portion 107 may be provided on an outermost side of the optical adjustment layer 103.

(4) In the features (1) and (2), the thin film portion 107 may be concentrically provided on the outer side of the first region 105.

(5) In the features of (1) to (4), the thin film portion 107 may be defined by a recess provided in a surface shape of the optical adjustment layer 103 in contact with the second region 106.

According to this feature, the optical adjustment layer 103 is further provided on the outer periphery of the thin film portion 107, and this absorbs variation in supply amount of a raw material of the optical adjustment layer 103. Thus, the thin film portion 107 can be formed reliably.

(6) In the features (1) to (4), a projecting portion 401 may be provided in at least a part of the second region 106 of the base 102 and at a position corresponding to the thin film portion 107.

According to this feature, the thin film portion 107 is formed by the projecting portion 401 of the base 102 to restrict bubbles from remaining in the optical adjustment layer 103.

(7) In the features (1) to (6), a rugged shape 108 may be provided in at least a part of the second region 106 of the base 102.

According to this feature, an anchor effect is exerted by the increase in contact interface area between the base 102 and the optical adjustment layer 103, and this increases adhesion therebetween.

(8) In the features (1) to (7), a rugged shape 706 having ruggedness finer than the film thickness of the thin film portion 107 may be provided in at least a part of a surface shape of the optical adjustment layer 103 in contact with the second region 106 of the base 102.

According to this feature, the contact area between the optical adjustment layer 103 and the mold 311 is reduced. As a result, even the diffractive optical element of the present disclosure having the thin film portion 107 is easily released from the mold 311. This can suppress deterioration of the optical characteristics and yield due to peeling of the optical adjustment layer 103.

(9) In the features (1) to (8), a depth of the diffraction grating 104 may be within a range of 2 to 20 μm.

(10) In the features (1) to (9), the base 102 may be formed of a first optical material containing a first resin.

According to this feature, fine working can be easily performed by molding or by other working methods, for example, the pitch of the diffraction grating 104 can be reduced.

(11) In the features (1) to (10), the optical adjustment layer 103 may be formed of a second optical material containing a second resin.

(12) In the feature (10), the first resin may be thermoplastic resin.

According to this feature, injection molding that is particularly excellent in productivity can be adopted in production of the base 102.

(13) In the feature (11), the second resin may be energy curable resin.

(14) In the features (11) and (13), the second optical material may further contain inorganic particles, and the inorganic particles may be dispersed in the second resin.

According to this feature, the refractive index and Abbe number of the second optical material can be adjusted finely. For this reason, the number of candidates of combinations of the first optical material and the second optical material that satisfy Expression 2 can be increased, and the difference in refractive index from the base 102 can be made larger than when the second resin is used alone.

(15) In the feature (10), the base does not have to contain thermosetting resin and energy curable resin.

(16) In the feature (10), the base may be substantially formed of thermoplastic resin.

(17) A production method for a diffractive optical element according to the present disclosure includes preparing a base 102 having, on a surface, a first region 105 with a diffraction grating 104 and a second region 106 located on an outer side of the first region 105, providing a raw material 312 of an optical material on the surface of the base 102, pressing the raw material 312 to cover the first region 105 and at least a part of the second region 106, and forming an optical adjustment layer 103 of the optical material by curing the raw material 312. In pressing the raw material, a thin film portion 107 having a film thickness smaller than a maximum film thickness of a portion of the optical adjustment layer 103 in contact with the second region 106 is formed in at least a part of the portion of the optical adjustment layer 103 in contact with the second region 106.

According to the feature of the present disclosure, it is possible to produce the diffractive optical element in which bubbles are restricted from remaining within the optical adjustment layer 103 and/or on an interface between the base 102 and the optical adjustment layer 103 and which is excellent in productivity and long-term reliability.

(18) In the feature (17), the film thickness of the thin film portion 107 may be within a range of 2% to 50% of the maximum film thickness of the portion of the optical adjustment layer 103 in contact with the second region 106.

According to this feature, bubbles can be more markedly restricted from remaining within the optical adjustment layer 103 and/or on the interface between the base 102 and the optical adjustment layer 103.

In the feature (17), the film thickness of the thin film portion 107 may be within a range of 2% to 20% of the maximum film thickness of the portion of the optical adjustment layer 103 in contact with the second region 106.

According to this feature, bubbles can be more markedly restricted from remaining within the optical adjustment layer 103 and/or on the interface between the base 102 and the optical adjustment layer 103.

(19) In the features (17) and (18), in pressing the raw material, a mold having a curved shape 313 in an area corresponding to the first region 105 and a projecting portion 322, 703 in at least a part of an area corresponding to the second region 106 may be used and the thin film portion 107 may be formed in correspondence the projecting portion of the mold.

According to this feature, it is possible to produce the diffractive optical element in which the thin film portion 107 is formed by the projecting portion 322, 703 of the mold to restrict bubbles from remaining in the optical adjustment layer 103.

(20) In the features (17) and (18), a projecting portion 401 may be provided in at least a part of the second region 106 of the base 102, and the thin film portion 107 may be formed in correspondence with the projecting portion 401 of the base 102 in pressing the raw material.

According to this feature, it is possible to produce the diffractive optical element in which the thin film portion 107 is formed by the projecting portion 401 of the base 102 to restrict bubbles from remaining in the optical adjustment layer 103.

(21) In the features (17) to (20), a rugged shape 108 may be provided in at least a part of the second region 106 of the base 102.

According to this feature, an anchor effect is exerted by the increase in contact interface area between the base 102 and the optical adjustment layer 103, and this increases adhesion therebetween.

(22) In the features (20) and (21), a rugged shape having ruggedness finer than the film thickness of the thin film portion 107 may be provided in at least a part of an area of the mold corresponding to the second region 106.

According to this feature, the contact area between the optical adjustment layer 103 and the mold 311 is reduced. As a result, even the diffractive optical element of the present disclosure having the thin film portion 107 is easily released from the mold 311. This can suppress deterioration of the optical characteristics and yield due to peeling of the optical adjustment layer 103.

(23) In the features (17) to (22), the raw material 312 of the optical material may contain energy curable resin, and the raw material 312 may be cured by the application of energy in forming the optical adjustment layer 103.

(24) In the feature (23), in providing the raw material of the optical material, a viscosity of the raw material of the optical material at 60° C. may be within a range of 1 to 1000 Pa·s.

According to this feature, bubbles can be restricted from remaining within the optical adjustment layer 103 and/or on the interface between the base 102 and the optical adjustment layer 103 in an effective region of the diffractive optical element by using the raw material of the optical adjustment layer 103 having a generally used viscosity such as to be easily treated in the production method.

(25) A mold according to the present disclosure is used to produce the diffractive optical element (1), and includes a curved shape 313 in an area corresponding to the first region 105 and a projecting portion 322, 703 in a part of an area corresponding to the second region 106.

According to the feature of the present disclosure, it is possible to provide the mold that produces the diffractive optical element in which bubbles are restricted from remaining within the optical adjustment layer 103 and/or on the interface between the base 102 and the optical adjustment layer 103 and which is excellent in productivity and long-term reliability.

For example, the diffractive optical element according to the present disclosure can be used as an imaging lens in a camera module, such as a module in a mobile phone, a vehicle-mounted module, a monitoring module, and an image sensing module. The diffractive optical element of the present disclosure can be applied not only to the imaging lens, but also to, for example, a spatial low-pass filter and a polarization hologram.

What is claimed is:

1. A diffractive optical element comprising:
a base having, on a surface, a first region with a diffraction grating and a second region located on an outer side of the first region; and
an optical adjustment layer provided on the surface to be in contact with the first region and at least a part of the second region,
wherein a thin film portion having a film thickness smaller than a maximum film thickness of a portion of the optical adjustment layer in contact with the second region is provided in at least a part of the portion of the optical adjustment layer in contact with the second region, and
wherein a rugged shape having ruggedness finer than the film thickness of the thin film portion is provided in at least a part of a surface shape of the optical adjustment layer in contact with the second region of the base.

2. The diffractive optical element according to claim 1, wherein the film thickness of the thin film portion is within a range of 2% to 50% of the maximum film thickness of the portion of the optical adjustment layer in contact with the second region.

3. The diffractive optical element according to claim 1, wherein the thin film portion is provided on an outermost side of the optical adjustment layer.

4. The diffractive optical element according to claim 1, wherein the thin film portion is concentrically provided on an outer side of the first region.

5. The diffractive optical element according to claim 1, wherein the thin film portion is defined by a recess provided in the surface shape of the optical adjustment layer in contact with the second region.

6. The diffractive optical element according to claim 1, wherein a projecting portion is provided in at least a part of the second region of the base and at a position corresponding to the thin film portion.

7. The diffractive optical element according to claim 1, wherein a rugged shape is provided in at least a part of the second region of the base.

8. The diffractive optical element according to claim 1, wherein a depth of the diffraction grating is within a range of 2 to 20 μm.

9. The diffractive optical element according to claim 1, wherein the base is formed of a first optical material containing a first resin.

10. The diffractive optical element according to claim 1, wherein the optical adjustment layer is formed of a second optical material containing a second resin.

11. The diffractive optical element according to claim 9, wherein the first resin is thermoplastic resin.

12. The diffractive optical element according to claim 10, wherein the second resin is energy curable resin.

13. The diffractive optical element according to claim 10, wherein the second optical material further contains inorganic particles, and the inorganic particles are dispersed in the second resin.

14. The diffractive optical element according to claim 9, wherein the base does not contain thermosetting resin and energy curable resin.

15. The diffractive optical element according to claim 9, wherein the base is substantially formed of thermoplastic resin.

16. A production method for a diffractive optical element comprising:
preparing a base having, on a surface, a first region with a diffraction grating and a second region located on an outer side of the first region;
providing a raw material of an optical material on the surface of the base;
pressing the raw material to cover the first region and at least a part of the second region; and
forming an optical adjustment layer of the optical material by curing the raw material,
wherein, in pressing the raw material, a thin film portion having a film thickness smaller than a maximum film thickness of a portion of the optical adjustment layer in contact with the second region is formed in at least a part of the portion of the optical adjustment layer in contact with the second region, and
wherein a rugged shape having ruggedness finer than the film thickness of the thin film portion is provided in at least a part of a surface shape of the optical adjustment layer in contact with the second region of the base.

17. The production method for the diffractive optical element according to claim 16, wherein the film thickness of the thin film portion is within a range of 2% to 50% of the maximum film thickness of the portion of the optical adjustment layer in contact with the second region.

18. A mold used to produce the diffractive optical element according to claim 1, the mold having a curved shape in an area corresponding to the first region and a projecting portion in a part of an area corresponding to the second region.
